(19) United States
(12) Patent Application Publication
(10) Pub. No.: US 2019/0385413 A1
(43) Pub. Date: Dec. 19, 2019

(54) SYSTEM AND METHOD FOR WAGERING THE VALUE OF A FINANCIAL TRANSACTION

(71) Applicant: CANTOR INDEX LLC, New York, NY (US)

(72) Inventors: Joseph M. Asher, Las Vegas, NV (US); Ashwini K. Chhabra, New York, NY (US); Howard W. Lutnick, New York, NY (US)

(21) Appl. No.: 16/552,292

(22) Filed: Aug. 27, 2019

Related U.S. Application Data
(63) Continuation of application No. 10/651,537, filed on Aug. 29, 2003, now abandoned.

(51) Int. Cl. G07F 17/32

(52) U.S. Cl. CPC G07F 17/3288

(57) ABSTRACT

A system for establishing a wager comprises a memory and a processor. The memory stores a value of a prize for a wager, and a risk value for the wager. The processor is coupled to the memory and determines odds for the wager, wherein the odds are based at least in part upon the value of the prize and the risk value. The processor further determines whether the wager is won as a function of the determined odds.

### CROSS-REFERENCE TO RELATED APPLICATIONS

This patent application is a continuation application of U.S. patent application Ser. No. 10/651,537, filed Aug. 29, 2003, the disclosures of which is hereby incorporated by reference herein in its entirety.

### TECHNICAL FIELD OF THE INVENTION

The present invention relates generally to wagering systems and more particularly to a system and method for wagering the value of a financial transaction.

### BACKGROUND OF THE INVENTION

Wagering in casinos, on sporting events, and in lotteries is a large and growing industry throughout the world. Various types of betting products and systems exist that facilitate betting on the outcome of a particular game. For example, a patron in a casino may bet on a single hand of blackjack, a pull on a slot machine, a roll of the dice, etc. Typical horse racing bets allow bettors to wager on a single horse or on several horses in a particular race or series of races. Lotteries allow patrons the opportunity to win sizeable jackpots by preselecting a predetermined number of randomly drawn numbers. A problem with these prior types of wagering is that they are neither readily accessible to patrons nor presented in a format that is flexible for the patron according to the patron's wagering needs or desires.

### SUMMARY OF THE INVENTION

In one embodiment, a method for establishing a wager comprises determining a prize for a wager and determining a risk value for the wager. The method continues by determining odds associated with the wager, wherein the odds are based at least in part upon a value of the prize and the risk value. The method concludes by determining whether the wager is won as a function of the determined odds.

In another embodiment, a system for establishing a wager comprises a memory and a processor. The memory stores a value of a prize for a wager, and a risk value for the wager. The processor is coupled to the memory and determines odds for the wager, wherein the odds are based at least in part upon the value of the prize and the risk value.

The processor further determines whether the wager is won as a function of the determined odds.

Various embodiments of the present invention may benefit from numerous advantages. It should be noted that one or more embodiments may benefit from some, none, or all of the advantages discussed below. An advantage of the system and method described herein is that the value of a financial transaction may now be wagered according to odds that are dynamically determined based upon the value of the prize of the wager and the risk value associated with the wager. The wagering system and method described herein may be implemented in a number of environments associated with different financial transactions, such as purchase transactions, installment loan transactions, revolving credit transactions, cash withdrawal transactions, and cash transfer transactions. In this regard, the wagering system and method described herein may be widely available to the betting public. Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates one embodiment of a system for wagering the value of a financial transaction according to the present invention; and

FIG. 2 illustrates one embodiment of a method for wagering the value of a financial transaction according to the present invention.

### DETAILED DESCRIPTION OF EXAMPLE EMBODIMENTS OF THE INVENTION

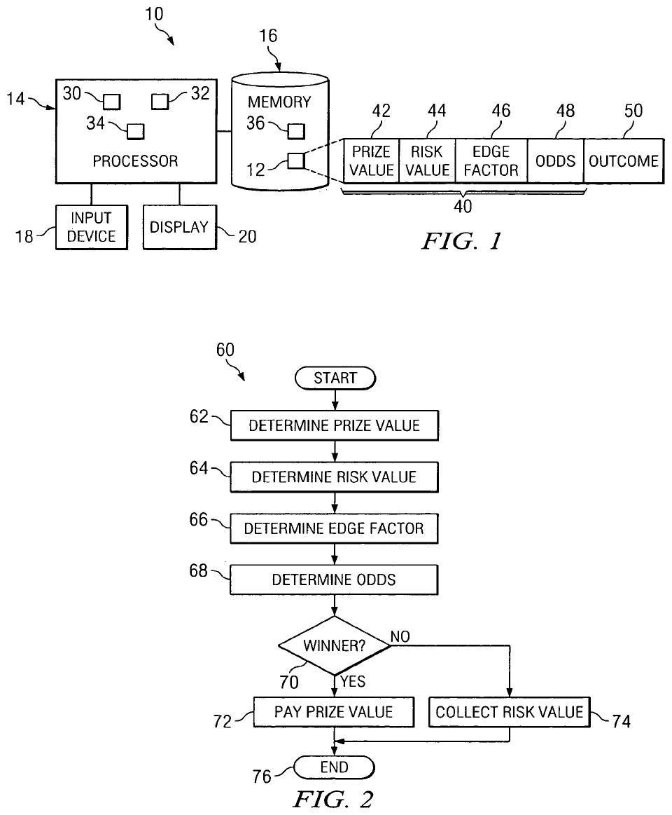

FIG. 1 illustrates one embodiment of a system 10 for establishing and processing a wager 12. Depending upon particular implementations of system 10, as described below, system 10 comprises one or more of a processor 14, a memory 16, an input device 18, and a display 20. In general, system 10 determines odds for a wager 12 based upon a selected prize value and a selected risk value, and determines whether the wager 12 is won as a function of the determined odds.

Processor 14 comprises any suitable number and combination of processing modules, such as, for example, wager input module 30, odds determination module 32, and outcome determination module 34. Each processing module comprises any suitable combination of hardware and software to perform the functionality described herein. Processing modules 30-34 may be integrated and/or distributed according to particular needs or desires. Memory 16 comprises any suitable arrangement of volatile and/or non-volatile memory that stores software 36 that is executable by processor 14 to establish and process wagers 12 according to the particular techniques described herein. Memory 16 also stores the particular parameters of a wager 12. Input device 18 comprises a keyboard or keypad, a push-button, a touch-screen, a game controller, or any other device suitable to receive input parameters associated with wagers 12, such as, for example, the prize value of the wager 12 and the risk value of the wager 12. Display 20 comprises any device suitable to convey the parameters and/or results of a wager 12 either audibly or visually. The existence and/or type of input device 18 and/or display 20 may be determined based upon the particular environment of system 10 that is implemented.

Wager 12 comprises a series of wager parameters 40 and an outcome 50. Wager parameters 40 comprise a prize value 42, a risk value 44, edge factor 46, and odds 48. In general, prize value 42 comprises the value stood to be won by a wagerer, and risk value 44 comprises the value stood to be lost by a wagerer. The wagerer may specify one or both of prize value 42 and risk value 44 to system 10. Edge factor 46 comprises a “vigorish” that is associated with any particular wager 12, and may change among wagers 12 based at least in part upon one or both of prize value 42 and risk value 44. System 10 determines odds 48 based at least in part upon prize value 42, risk value 44, and edge factor 46, as described below. System 10 determines outcome 50—whether the wager 12 is won or lost—as a function of the determined odds 48.

Prize Value

In particular embodiments, prize value 42 comprises a value of an underlying financial transaction. Examples of underlying financial transactions include at least a purchase transaction, an installment loan transaction, a revolving credit transaction, and a cash withdrawal or transfer transaction. These different types of financial transactions, and the wagers 12 that are derived therefrom, may occur in different financial environments. Moreover, system 10 used to establish and process wagers 12 may be implemented differently among the different types of financial transactions.

Purchase Transactions

Purchase transactions comprise those transactions whereby the wagerer purchases goods and/or services for a particular monetary amount. With respect to purchase transactions, therefore, the prize value 42 of a wager 12 comprises a value that is derived from the amount of a purchase. For example, a wagerer may purchase a meal at a restaurant for $3.25. The restaurant may then offer a wager 12 whereby the prize value 42 of the wager 12 is the cost of the meal, $3.25, or some portion thereof. Therefore, if the wagerer wins the wager 12, then the wagerer wins the meal for free or at least wins a portion of the purchase price of the meal. In another example, a wagerer may purchase a candy bar from a vending machine for $0.80. The vending machine may then offer a wager 12 whereby the prize value 42 of the wager 12 is the cost of the candy bar, $0.80, or some portion thereof. Therefore, if the wagerer wins the wager 12, then the wagerer wins the candy bar for free or at least wins a portion of the purchase price of the candy bar. In both of the above-identified examples, the wager 12 may be formed such that the wagerer stands to win an “in-kind” prize. For example, with respect to the candy bar purchased from the vending machine, the wager 12 may be formed such that the wagerer stands to win a second candy bar for the price of the risk value 44, rather than receiving the first candy bar for free. Similarly, with respect to the meal at the restaurant, the wager 12 may be formed such that the wagerer stands to win a second meal, or a gift certificate for a second meal, at the restaurant for the price of the risk value 44, rather than receiving the first meal for free.

Other examples of purchase transactions in which a wager 12 may be formed are virtually limitless. The purchase transactions and associated wager 12 could take place by the wagerer in person, such as at a point-of-sale equipment (e.g., cash register, vending machine, self-scan devices, debit card processing terminals, etc.). The purchase transactions and associated wager 12 could take place by standard mail (e.g., electric bill, phone bill, cable television bill, etc.). The purchase transactions and associated wager 12 could take place via the Internet (e.g., online e-tailers, auction web-sites, travel web-sites, etc.). In each of these different environments, the prize value 42 may be associated with the price of the good and/or service that is purchased, or a portion thereof.

Moreover, system 10 may be designed and/or modified to work with and/or within other equipment that is used to implement the particular type of purchase transaction. For example, system 10 may be integrated into and/or work in conjunction with purchase processing systems and computers associated with a manufacturer, wholesaler, retailer, or another merchant or offeror of goods and/or services. For example, system 10 may be integrated into point-of-sale equipment or into payment processing systems associated with the Internet.

Installment Loan Transactions

Installment loan transactions comprise those transactions whereby the wagerer takes an installment loan in order to pay for goods and/or services. With respect to installment loan transactions, therefore, the prize value 42 of a wager 12 comprises a value that is derived from the amount of a loan. For example, a wagerer may take a loan from a bank to purchase a car for $25,000. The monthly payment on the car loan may be $300. The bank may then offer a wager 12 whereby the prize value 42 of the wager 12 is the cost of one month's car loan payment, $300, or some portion thereof. Therefore, if the wagerer wins the wager 12, then the wagerer wins the car loan payment for that month, or some portion thereof. In particular embodiments, a lender may offer a type of installment loan whereby the debtor is provided an automatic entry into a monthly wager 12 and stands to win a free payment for that month. In this embodiment, the debtor may not be required to pay risk value 44 to establish the wager 12. Instead, the establishment of the wager 12 would be a benefit of establishing the loan with that particular lender. In this regard, this embodiment exemplifies an incentive associated with wager 12 which may be applicable to financial transactions of types other than installment loan transactions as well. Incentives such as the one described above are described in greater detail below with regard to risk value 44. Other examples of installment loan transactions and wagers derived therefrom may involve mortgage loan payments, school tuition payments, or any other payment on an installment loan.

System 10 may be designed and/or modified to work with and/or within other equipment that is used to implement the particular type of installment loan transaction. For example, system 10 may be integrated into and/or work in conjunction with loan processing systems and computers associated with a lender, such as a bank, or other entities associated with the installment loan, such as a mortgage company or a school.

Revolving Credit Transactions

Revolving credit transactions comprise those transactions whereby the wagerer borrows against a revolving line of credit to pay for goods and/or services. With respect to credit transactions, therefore, the prize value 42 of a wager 12 comprises a value that is derived from the amount borrowed against the line of credit. For example, a wagerer may borrow against a line of credit offered by a credit card company to make several purchases over the course of a period of time, such as one month. The amount borrowed against the line of credit for one month may be, for example, $3,545.48. Multiple items may have been purchased using the line of credit in order to total $3,545.48. The credit card company may then offer a wager 12 whereby the prize value 42 of the wager 12 is the amount borrowed against the line of credit, $3,545.48, for one month. Therefore, if the wagerer wins the wager 12, then the wagerer wins the $3,545.48. In other words, the credit card company would forgive the balance owed by the wagerer for payment of the amount borrowed against the line of credit for that month. Alternatively, or in addition, the credit card company may offer one or more wagers 12 whereby the prize value 42 is the amount borrowed against the line of credit for any suitable number and combination of items purchased using the line of credit. Therefore, the prize value 42 may be any suitable portion of the total amount borrowed against the line of credit for the one month. If the wagerer wins the wager 12, then the wagerer wins the amount borrowed against the line of credit in order to purchase the subset of items identified.

System 10 may be designed and/or modified to work with and/or within other equipment that is used to implement the particular type of credit transaction. For example, system 10 may be integrated into and/or work in conjunction with credit processing systems and computers associated with a credit card company. In this regard, the credit card company could offer wager 12 from month to month via credit card statements that may be accessed using regular mail, telephone, the Internet, or any other suitable communication technique. In addition, the credit card company could implement system 10 to maintain profiles on particular patrons in order to offer customized variations of wager 12 and/or to automatically establish one or more wagers 12 based upon authorizations pre-provided by a patron and maintained in a profile. Such techniques for maintaining profiles and automatically establishing wagers 12 could apply to any type of financial transaction described herein.

Cash Withdrawal and Transfer Transactions

Cash withdrawal transactions comprise those transactions whereby a wagerer withdraws an amount of money from an account. With respect to these transactions, therefore, the prize value 42 of a wager 12 comprises a value that is derived from the amount withdrawn. For example, a wagerer may withdraw $100 from an account using an Automated Teller Machine (ATM). The account provider, such as a bank, may then offer a wager 12 whereby the prize value 42 of the wager 12 is the amount withdrawn, $100, or some portion thereof. Therefore, if the wagerer wins the wager 12, then the wagerer stands to win the amount withdrawn, or some portion thereof. Cash transfer transactions comprise those transactions whereby a wagerer transfers an amount of money from one account to another account. With respect to these transactions, therefore, the prize value 42 of a wager 12 comprises a value that is derived from the amount transferred. Wagers 12 derived from cash transfer transactions may involve wire transfers of money, for example.

System 10 may be designed and/or modified to work with and/or within other equipment that is used to implement the particular type of cash withdrawal or transfer transaction. For example, system 10 may be integrated into and/or work in conjunction with cash withdrawal and transfer systems and computers associated with a bank (e.g., ATM) or a wire transfer company (e.g., wire transfer terminal).

Risk Value

In some embodiments, risk value 44 may comprise a predetermined amount that is independent of the prize value 42. For example, with respect to a purchase transaction involving a meal at a restaurant, the risk value 44 may be set at a predetermined value, such as $1.00. In other embodiments, risk value 44 may comprise a percentage of the prize value 42. For example, with respect to a purchase transaction involving the meal at a restaurant, the risk value 44 may be set at 1% of the value of the purchase transaction. In still other embodiments, risk value 44 may comprise the difference between an amount tendered by a wagerer for a financial transaction and the amount that was owed by the wagerer for the financial transaction. For example, with respect to a purchase transaction, the wagerer may have inserted 1.00 into a vending machine (e.g., amount tendered) in order to purchase a candy bar for $0.80 (e.g., amount owed). In this example, rather than receive the change of $0.20, the wagerer may decide to risk the 0.20 in order for the chance to win the candy bar. Therefore, the risk value in this example is 0.20.

Risk Value Incentives

In particular examples, the risk value 44 may be reduced through the use of incentives, such as reward points or reward coupons. For example, the wagerer may accumulate reward points through a series of prior financial transactions (e.g., reward points earned based upon prior credit transactions). The wagerer may then redeem these reward points in order to reduce the risk value 44 of a particular wager 12. Although the risk value 44 of the particular wager 12 may be reduced from a first value 44 to a second, lesser value 44, the odds 48 would be determined for that wager based upon the first, greater value 44. For example, if a wagerer had earned 100 reward points through the performance of prior financial transactions, the wagerer may be entitled to reduce a risk value 44 from $1.00 to $0.50 for a particular wager 12. System 10 would determine the odds 48 for that wager 12 based upon a risk value 44 of $1.00, however. In addition to the use of reward points to reduce a risk value 44, a wagerer may use risk value coupons. Risk value coupons may be circulated to wagerers by an establishment in order to promote the wagering described herein. For example, the restaurant offering a wager 12 for the meal purchased by the wagerer may offer a promotional risk value coupon for $0.50 off the risk value 44 of $1.00 that may be traditionally offered by that restaurant.

Other examples of incentives could include balance incentives or threshold incentives. In particular, a credit card company could offer an incentive whereby system 10 will automatically establish a wager 12 for a wagerer by virtue of the fact that the wagerer has a balance on his credit card, for example. The balance could be an amount charged using the credit card for a current month or an amount accumulated for charges in previous months, for example. The prize value 42 may be all or a portion of the balance and the risk value 44 may be determined by the size of the balance. Therefore, as the size of the balance increases, the risk value 44 would increase according to a step function or linearly. Since the risk value 44 would be paid by the credit card company, or some other financial institution, and is not paid by the wagerer as with traditional wagers 12, the incentive to the wagerer is to spend more money using the credit card. Threshold incentives would work similarly except that the incentive would be triggered as the user of the credit card surpassed one or more spending thresholds in a given month, or cumulatively over time. Although the incentives have been described herein with reference to a credit transaction, it should be understood that any or all of the incentives described are applicable to any type of financial transaction.

Wager input module 30 of processor 14 may determine both prize value 42 and risk value 44 for a particular wager 12 and store these values in memory 16 as wager parameters 40.

Odds Determination

Odds determination module 32 of processor 14 determines edge factor 46 and odds 48 for a particular wager 12. In one embodiment, module 32 determines odds 48 for a particular wager 12 based upon the following formula: odds 48=(prize value 42/risk value 44)*edge factor 46. Therefore, odds 48 are variable based at least in part upon the prize value 42 and the risk value 44.

Memory 16 may store particular edge factors 46 in association with particular types of underlying financial transactions. In particular embodiments, the edge factor 46 may also vary as a function of either or both of prize value 42 and risk value 44. For example, edge factor 46 may be reduced from 1.25 to 1.15 (e.g., thereby reducing the vigorish from 25% to 15%) based upon the size of either or both of prize value 42 and risk value 44. In particular embodiments, edge factor 46 varies inversely to the size of risk value 44. Therefore, as risk value 44 increases, edge factor 46 may decrease toward a minimum edge factor 46 (e.g., edge factor 46 of 1.05 may be a minimum). As risk value 44 decreases, edge factor 46 may increase toward a maximum edge factor 46 (e.g., edge factor 46 of 1.30 may be a maximum). Edge factor 46 may vary inversely in response to risk value 44 according to a step function or a linear function depending upon particular implementations. Edge factor 46 may also vary in response to a risk value incentive, similar to the way risk value 44 varies in response to a risk value incentive, as described above.

Returning to the example of the wager 12 based upon the purchase transaction of a candy bar at a vending machine, the prize value may be $0.80, the risk value may be $0.20, and the edge factor 46 may be 1.25, such that the odds 48 are calculated to be 5-to-1. The true odds of such a wager—the odds that would result if the edge factor were one—are actually 4-to-1.

Returning to the example of the wager 12 based upon the purchase transaction of a candy bar at a vending machine wherein the prize is an “in-kind” prize, such as a second candy bar, the prize value 42 is the value of the second candy bar, $0.80, minus the risk value 44, 50.20. Therefore, prize value 42 is $0.60 for this example. If the edge factor 46 were one, then the true odds of a wager 12 based on this transaction would be 3-to-1. If the edge factor 46 is again 1.25, as in the example above, then the determined odds for this wager 12 are 15-to-4.

Wager Outcome

Outcome determination module 34 of processor 14 determines whether wager 12 is won as a function of the determined odds 48. For example, outcome determination module 34 may perform a random selection of a number whereby a particular one number is associated with “win” and the remaining numbers are associated with “lose.” In the example where the wager 12 is based upon the candy bar sold at the vending machine, the odds 48 are 5-to-1 and the particular number associated with “win” is therefore one of five numbers. Therefore, the wagerer has a 20% chance of winning the candy bar from the vending machine in this example. If the outcome 50 of the wager 12 is “win,” then the wagerer wins the candy bar and the original $1.00 deposited into the vending machine is returned to the wagerer. If the outcome 50 of the wager 12 is “lose,” then the wagerer receives the candy bar but the entire $1.00 deposited by the wagerer is kept by the vending machine.

FIG. 2 illustrates one embodiment of a flowchart 60 for establishing and processing a wager 12. Processor 14 determines prize value 42 at step 62 and risk value 44 at step 64 based upon the techniques for calculating these values according to the particular underlying financial transaction for the wager 12, as described in detail above. Processor 14 determines edge factor 46 at step 66 based upon the particular type of financial transaction underlying the wager 12 and/or based upon the size of prize value 42 and/or risk value 44. Processor 14 then determines odds 48 at step 68 according to the following formula: odds 48=(prize value 42/risk value 44)*edge factor 46. Therefore, odds 48 are variable based at least in part upon the prize value 42 and the risk value 44.

Processor 14 determines whether the wager 12 is won at step 70 as a function of the odds 48 determined at step 68. If the wager 12 is won, as determined at step 70, execution proceeds to step 72 where the prize value 42 is paid to the wagerer. If the risk value 44 for the wager 12 was ever collected, then it too is paid back to the wagerer. If the wager 12 is lost, as determined at step 70, execution proceeds to step 74 where the risk value 44 is collected (if it has not already been collected) or kept (if it was previously collected). Execution terminates at step 76.

It should be understood that the flowchart of FIG. 2 is only one example of a method for establishing a wager 12. Other methodologies including any particular number, combination, and ordering of steps illustrated in the flowchart of FIG. 2 may be suitable.

Although embodiments of the invention and their advantages are described in detail, a person skilled in the art could make various alterations, additions, and omissions without departing from the spirit and scope of the present invention as defined by the appended claims.

1. (canceled)

2. An apparatus comprising:
a money element acceptor and dispenser device configured to accept insertion of a money element and dispense a money element;
a dispenser configured to dispense a prize from the apparatus; and
at least one processor configured to control:
receiving an indication from the money acceptor and dispenser device that a prospective wagerer has entered into a transaction for a good, a service or a financial transaction, the transaction being associated with a non-zero monetary value, by the wagerer inserting a first money element into the money acceptor and dispenser device, in which the indication indicates a value associated with the transaction; and
in response to receiving the indication,
offering to the wagerer, via a display device of the apparatus, an opportunity to wager for a first prize, the first prize having a value derived from the value of the transaction;
receiving from the wagerer a selection of a non-zero risk value for the wager;
computing an odds value for the wager, the computing based at least in part upon the value of the first prize and the risk value;
identifying an event having a possible outcome whose odds of occurring are equal to the odds value;
determining an actual outcome of the event;
determining whether the wager is won based at least in part on the actual outcome of the event; and
automatically in response to determining that the wager is won, dispensing from the dispenser the first prize.

3. The apparatus of claim 2, wherein the first prize is a gift certificate.

4. The apparatus of claim 2, further comprising:
wherein the at least one processor is configured to control:
accepting a risk value coupon inserted at the money element acceptor and dispenser device; and
computing the odds value for the wager based on the risk value coupon.

5. The apparatus of claim 2, wherein the first prize comprises an in-kind award.

6. The apparatus of claim 2, wherein the risk value is computed based at least in part on a difference between an amount tendered for the transaction and an amount owed for the transaction, and offered to the prospective wagerer for selection.

7. The apparatus of claim 2, wherein the risk value is computed as a fractional portion of the value of the first prize, and the at least one processor is configured to control suggesting the risk value to the wagerer for selection.

8. The apparatus of claim 7, wherein the risk value is computed by rounding up the fractional portion to a round integer or round fraction of a unit of currency.

9. The apparatus of claim 2, wherein the risk value comprises a percentage of the value of the first prize.

10. The apparatus of claim 2, wherein at least a portion of the risk value used in computing the odds value includes an incentive plan reward from a previous transaction.

11. The apparatus of claim 10, wherein a risk value incentive associated with the incentive plan reward comprises at least one of a reward point, a risk value coupon, a balance incentive or a threshold incentive.

12. The apparatus of claim 2, wherein the odds value is computed by dividing the value of the first prize by the risk value to form a quotient and by multiplying the quotient by an edge factor.

13. The apparatus of claim 12, wherein the value of the edge factor varies from a minimum edge factor to a maximum edge factor.

14. The apparatus of claim 12, wherein the value of the edge factor varies inversely with the risk value.

15. The apparatus of claim 12, wherein the value of the edge factor is based at least in part upon a value of an incentive plan reward from a previous transaction.
